(19) United States
(12) Patent Application Publication
(10) Pub. No.: US 2020/0313229 A1
(43) Pub. Date: Oct. 1, 2020

(54) ELECTRODE BODY FOR ALL-SOLID-STATE BATTERY AND PRODUCTION METHOD THEREOF

(71) Applicant: TOYOTA JIDOSHA KABUSHIKI KAISHA, Toyota-shi, Aichi-ken (JP)

(72) Inventors: Kengo HAGA, Nagoya-shi, Aichi-ken (JP); Hideki ASADACHI, Toyota-shi, Aichi-ken (JP)

(21) Appl. No.: 16/755,339

(22) PCT Filed: Nov. 20, 2018
(86) PCT No.: PCT/JP2018/042887

§ 371 Date: Apr. 10, 2020

Related U.S. Application Data
(63) Continuation-in-part of application No. 16/184,109, filed on Nov. 8, 2018, now abandoned.

(30) Foreign Application Priority Data
Nov. 21, 2017 (JP) 2017-223700

(51) Int. Cl. H01M 10/0562; H01M 4/04; H01M 4/62; H01M 10/0564; H01M 10/0525

(52) U.S. Cl. CPC H01M 10/0562; H01M 4/0435; H01M 10/0525; H01M 10/0564; H01M 4/621

(57) ABSTRACT

Provided is a method for producing an electrode body for an all-solid-state battery whereby cracks in the solid electrolyte layer can be suppressed even when the electrode body is pressed at a higher pressure, along with an electrode body produced by this method. The method for producing an electrode body for an all-solid-state battery disclosed herein is a method for manufacturing an electrode body for an all-solid-state battery including a solid electrolyte layer and a first active material layer bonded to a first surface of the solid electrolyte layer, including a step of superimposing the solid electrolyte layer and the first active material layer when there is a difference between the area of the solid electrolyte layer and the area of the first active material layer at the bonding surface between the solid electrolyte layer and the first active material layer, a step of providing an insulating layer in a region where it contacts the edges of the smaller of the solid electrolyte layer and the first active material layer and fills in the difference between the layers, a step of pressing the solid electrolyte layer, the first active material layer and the insulating layer in the lamination direction of the solid electrolyte layer and the first active material layer.

This is a US National Stage of International Application No. PCT/JP2018/042887, filed Nov. 20, 2018, which claims priority to Japanese Patent Application No. 2017-223700 filed on Nov. 21, 2017 and U.S. patent application Ser. No. 16/184,109 filed in Nov. 8, 2018, the entire contents of which are herein incorporated by reference.

### TECHNICAL FIELD

The present disclosure relates to an electrode body for all-solid-state batteries, and to a production method thereof.

### BACKGROUND ART

Secondary batteries have become indispensable in recent years as portable power sources for personal computers, mobile terminals and the like, as power sources for vehicle drive in electric vehicles (EV), hybrid vehicles (HV) and plug-in hybrid vehicles (PHV), and as power sources for power storage. Among the foregoing, the widespread use of lithium ion batteries, spurred by the high energy density and high-rate output that these batteries afford, has been accompanied by demands for higher performance and improved reliability of the batteries.

Among such secondary batteries, all-solid-state batteries that utilize a solid electrolyte made up for instance of a ceramic or an ion-conductive polymer, without resorting to a flammable electrolyte solution as an electrolyte, are being adopted in practical use with a view to increasing safety. In all-solid-state batteries a layered solid electrolyte is disposed between a positive electrode active material layer and a negative electrode active material layer, to configure thereby an electrode body. The solid electrolyte layer and the positive/negative active material layers can be formed as dense thin films, by CVD or the like, but are ordinarily obtained through binding of powdery (particulate) electrode constituent materials, for instance in terms of cost and productivity.

### CITATION LIST

### Patent Literature

[Patent Literature 1] Japanese Patent Application Publication 2015-050149
[Patent Literature 2] Japanese Patent Application Publication 2012-038425
[Patent Literature 3] Japanese Patent Application Publication 2014-203740
[Patent Literature 4] Japanese Patent Application Publication H09-153354

### SUMMARY OF INVENTION

### Technical Problem

The interface resistance between the solid electrolyte layer and the positive/negative active material layers is high, given the absence of an electrolyte solution. In all-solid-state batteries produced using powdery materials, moreover, interface resistance arises between particles, also within the solid electrolyte layer and the positive/negative active material layers. To reduce interface resistance, therefore, an electrode body produced by layering a positive electrode active material layer, a solid electrolyte layer and a negative electrode active material layer is pressed at a higher pressure than for a liquid battery (such as a surface pressure of about 100 to 200 MPa) to thereby increase the packing density of the layers. During pressing of the electrode body, tensile stress can act in a direction perpendicular to the pressing direction, and as a result short-circuits may occur on account of contact between the edges of the positive electrode active material layer and the edges of the negative electrode active material layer, opposing each other across the solid electrolyte layer. In order to prevent such short-circuits, therefore, it has been proposed for instance to design the width of one of the active material layers (for instance the positive electrode active material layer) to be smaller. Configurations in which the ends of the solid electrolyte layer or the positive or negative active material layer are covered with an insulator have also been proposed (see for example Patent Literature 1 to 3). The inventors then investigated pressing an electrode body at a higher pressure than in the past (such as a surface pressure above 200 MPa) with the aim of increasing the density of the layers of the electrode body and improving battery performance. However, we discovered a new problem, namely that the electrode body is more likely to short circuit when it has been pressed at a higher pressure.

The present invention provides a method for manufacturing an electrode body for an all-solid-state battery whereby short circuits of the electrode body can be suppressed even when the electrode body has been pressed at a higher pressure. It is another object of the present invention to provide an electrode body for an all-solid-state battery manufactured by this method.

### Solution to Problem

The inventors investigated the pressing step in the manufacture of conventional all-solid-state batteries in detail and discovered the following. That is, in configurations that involve reducing the dimensions of conventional active material layers, level differences (steps) are formed in the electrode body because the active material layers are present at some sites and absent at others on the surface of the solid electrolyte layer. Even with the configurations disclosed in Patent Literature 1 to 3, moreover, steps are formed by parts that are covered by the insulator and those that are not covered by the insulator at the edge of the solid electrolyte layer or active material layer. It has also been found that even if obvious steps are not formed, irregularities may occur in the tensile strength generated in the plane direction of the solid electrolyte layer, or the solid electrolyte layer may be subject to localized stress due to the presence of steps when the electrode body is pressed or when the electrode body is subject to pressure during battery use for example. Such stress irregularity or localized stress to the solid electrolyte layer has not been enough to adversely affect the electrode body in a battery manufactured at a conventional pressing pressure (such as a surface pressure of about 100 to 200 MPa). However, it has been found that when pressing is performed at a higher pressure than before, the stress irregularity and localized application of stress to the solid electrolyte layer can cause cracks and chipping in the solid electrolyte layer, leading to short circuits of the electrode body.

In the method disclosed here for manufacturing an electrode body for an all-solid-state battery, an electrode body for an all-solid-state battery is manufactured comprising a first active material layer bonded to a first surface of the aforementioned solid electrolyte layer. This manufacturing method comprises a step of superimposing the solid electrolyte layer and the first active material layer when there is a difference between the area of the solid electrolyte layer and the area of the first active material layer at the bonding surface between the solid electrolyte layer and the first active material layer, a step of providing an insulating layer in a region where it contacts the edges of the smaller of the solid electrolyte layer or the first active material layer and fills in the difference between the layers, and a step of pressing the solid electrolyte layer, the first active material layer and the insulating layer in the lamination direction of the solid electrolyte layer and the first active material layer.

In an all-solid-state battery, the solid electrolyte layer is often formed so as to be larger than at least one of the first active material layer and second active material layer with the aim of preventing short circuits between the first active material layer and second active material layer and the like. In such a configuration, an insulating layer is provided so as to fill in the area difference at the bonding surface between the solid electrolyte layer and the first active material layer. It is thus possible to reduce stress irregularity and application of localized stress due to differences between the bonded areas of each layer, and to suppress cracks and chipping of the solid electrolyte layer and consequently short circuits of the electrode body.

In a preferred embodiment of the method disclosed here for manufacturing an electrode body for an all-solid-state electrode, an electrode body is manufactured comprising a solid electrolyte layer, a first active material layer provided on a first surface of the solid electrolyte layer, and a second active material layer provided on a second surface on the opposite side from the first surface of the solid electrolyte layer. The production method includes steps (a) to (e) as follows. (a) Preparing the first active material layer. (b) Preparing the solid electrolyte layer in such a manner that a first surface of the first active material layer and the first surface of the solid electrolyte layer are in contact with each other. Herein, the second surface of the solid electrolyte layer includes a peripheral edge section that is at least part of a peripheral edge, and a stack section excluding the peripheral edge section. (c) Preparing the second active material layer so as to be in contact with the stack section of the solid electrolyte layer. (d) Preparing an insulating layer so as to be in contact with the peripheral edge section of the solid electrolyte layer. (e) Obtaining the electrode body by pressing a stack including the first active material layer, the solid electrolyte layer, the second active material layer and the insulating layer, in a stacking direction, until surfaces of at least the second active material layer and of the insulating layer are flush with each other.

In such a configuration, the first active material layer, the solid electrolyte layer and the second active material layer can be pressed all at once while in a stacked state, and the stack can be conveniently compacted. The second active material layer in the stack is found to be smaller than the solid electrolyte layer. Further, the insulating layer is provided at the peripheral edge section of the solid electrolyte layer. Accordingly, this allows suppressing short-circuiting caused by contact between the edge of the first active material layer and the edge of the second active material layer, even when the stack is pressed. Further, pressing of the stack is carried out until at least the thicknesses of the second active material layer and of the insulating layer are identical. In other words, the level difference formed between the solid electrolyte layer and the second active material layer is filled up by the insulating layer. The pressing pressure can be uniformly transmitted as a result by the solid electrolyte layer, via the second active material layer and the insulating layer, obviously when rolling is carried out at a pressure comparable to that of conventional instances, but also in the case of pressing at a pressure higher than in conventional instances. As a result, it becomes possible to suppress unevenness in tensile stress occurring in the solid electrolyte layer, and to suppress cracks in the solid electrolyte layer both during production of the electrode body and during use later on.

In some implementations of the method for producing an all-solid-state battery electrode body disclosed herein, the first active material layer, the solid electrolyte layer and the second active material layer each contain a powder material and a binder. The layers formed by the powder material and the binder tend to have low packing density and low strength. Therefore, adopting the present art in an electrode body formed using such materials is preferable on account of the distinctive effect that is elicited as a result.

In a preferred embodiment of the method disclosed here for manufacturing an electrode body for an all-solid-state electrode, the first active material layer, the solid electrolyte layer and the second active material layer are each prepared by supplying a slurry (here and below, includes pastes and suspensions) containing a powder material, a binder and a dispersion medium, and removing the dispersion medium.

Such a configuration is preferable since it allows producing an electrode body with good productivity and at a low cost.

In some implementations of the method for producing an all-solid-state battery electrode body disclosed herein, the method includes (b′) a drying step of, subsequently to the step (b), drying the first active material layer and the solid electrolyte layer.

Such a configuration allows preventing intermixing of for instance a slurry for forming the solid electrolyte layer and a slurry for forming the second active material layer. Further, it becomes possible to lay up the second active material layer on the first active material layer and the solid electrolyte layer, having been relatively hardened by drying, and to press the whole. Pressure by pressing can be transmitted sufficiently to the second active material layer as a result. The positive electrode active material is generally harder than the other materials, and accordingly the positive electrode active material layer is not compacted easily. Therefore, it is preferable for instance to use the second active material layer as the positive electrode active material layer, since doing so allows sufficiently compacting the positive electrode active material layer, which is relatively difficult to compact.

In some implementations of the method for producing an all-solid-state battery electrode body disclosed herein, the pressing is carried out under heating at a temperature equal to or higher than the softening point of the binder.

Such a configuration is preferable since it allows further increasing the packing density of the electrode body. For instance, the above configuration is preferred since the packing density of the electrode body can be increased up to 85 vol % or higher (preferably 90 vol % or higher), and interface resistance can be further reduced. A value measured using a pycnometer can be taken herein as the packing density. The packing density can be measured also by image analysis.

Pressing the layers while heating the layers in a stacked state allows the binder contained in the layers to bond the layers together. As a result, adhesion of the layers can be maintained and increases in internal resistance can be suppressed, also in the case of changes in the volume of electrode layers derived from charge and discharge.

In some implementations of the method for producing an all-solid-state battery electrode body disclosed herein, the pressing is carried out by flat pressing at a surface pressure of 200 MPa or higher. Alternatively, the pressing is carried out by roll rolling at a linear pressure of 10 kN/cm or higher.

Such a configuration allows reducing unevenness in tensile stress occurring in the solid electrolyte layer, and accordingly allows suppressing cracks in the solid electrolyte layer also when the electrode body is pressed at a pressure higher than in conventional instances. Such a configuration is preferable since it allows further increasing the packing density of the electrode body.

In some implementations of the method for producing an all-solid-state battery electrode body disclosed herein, the Young's modulus of the insulating layer that is prepared in the step (d) is 1/10 or more the compressive deformation resistance ratio of the second active material layer.

Such a configuration is preferable since in that case the deformation behavior of the insulating layer arising from pressing suitably mimics the deformation behavior of the second active material layer, and the pressing pressure can be transmitted more uniformly to the solid electrolyte layer.

In some implementations of the method for producing an all-solid-state battery electrode body disclosed herein, in the step (d) an insulating composition containing at least a photocurable resin composition is supplied to the peripheral edge section, and curing light is irradiated, to thereby prepare the insulating layer containing a photocurable resin.

Such a configuration is preferable since it allows shortening the time required for preparing the insulating layer.

In some implementations of the method for producing an all-solid-state battery electrode body disclosed herein, the insulating composition contains at least one type selected from the group consisting of porous ceramic powders, ceramic hollow particles, hollow aggregates of ceramic particles, porous resin particles, hollow resin particles and insulating fibrous fillers.

Such a configuration is preferable since it allows adjusting, to a desired value, the compression behavior of the insulating layer made up of an ultraviolet curable resin.

In some implementations of the method for producing an all-solid-state battery electrode body disclosed herein. The insulating layer is prepared through supply of a slurry containing the insulating ceramic particles, the binder and a dispersion medium, followed by removal of the dispersion medium. For example, the insulating layer preferably contains at least one of alumina and a solid electrolyte material.

Such a configuration is preferable since it allows forming an insulating layer exhibiting a deformation behavior derived from pressing similar to that of the second active material layer.

In some implementations of the method for producing an all-solid-state battery electrode body disclosed herein, in the step (a) the first active material layer is prepared on both faces of a collector.

Such a configuration allows forming, one at a time, a stack made up of the first active material layer, the solid electrolyte layer and the second active material layer, on both faces of the collector. This is preferable since in that case a higher capacity electrode body can be obtained in a simple manner, through pressing of two stacks and a collector at a time.

In another aspect, the art disclosed herein provides an electrode body for all-solid-state batteries. The electrode body is provided with a solid electrolyte layer, a first active material layer, a second active material layer, and an insulating layer. The solid electrolyte layer has a first surface and a second surface on the opposite side to the first surface, wherein the second surface includes a peripheral edge section that is at least part of a peripheral edge of the solid electrolyte layer, and a stack section excluding the peripheral edge section. The first active material layer is provided on the first surface, the second active material layer is provided on the stack section, and the insulating layer is provided on the peripheral edge section. Surfaces of the second active material layer and of the insulating layer, on the opposite side to the second surface, are flush with each other.

Such a configuration is preferable since cracks are unlikelier to occur in the solid electrolyte layer, from the time of production up to the time of use, even with increased packing density of the electrode body.

### BRIEF DESCRIPTION OF DRAWINGS

FIG. 1 is a flow diagram illustrating a method for producing an electrode body of an all-solid-state battery according to an embodiment of the present invention.

FIG. 2A is a plan-view diagram, and FIG. 2B a side-view diagram, illustrating schematically a production process of an electrode body of an all-solid-state battery according to an embodiment of the present invention.

FIGS. 3A to 3E are cross-sectional schematic diagrams along line IIIa through line IIIe in FIG. 2(A).

FIG. 4 is a cross-sectional diagram of an electrode body after rolling in accordance with a conventional method.

FIG. 5A is a cross-sectional schematic diagram of an electrode body before rolling and FIG. 5B is a cross-sectional schematic diagram of an electrode body after rolling, the diagrams of FIGS. 5A and 5B illustrating another embodiment.

FIG. 6 is a graph showing one example of the results of CAE analysis of the relationship between the elastic modulus and the thickness of the insulating layer relative to the positive electrode active material layer when the positive electrode active material layer and insulating layer are in a pressed state after having been pressed under predetermined conditions.

### DESCRIPTION OF EMBODIMENTS

Embodiments of the present disclosure will be explained below. Any features (for example, ordinary features in electrode bodies for all-solid-state batteries and not being characterizing features of preferred embodiments of the present invention) other than the matter specifically set forth in the present specification and that may be necessary for carrying out the present invention can be regarded as design matter for a person skilled in the art based on conventional techniques in the relevant technical field. Embodiments of the present invention can be realized on the basis of the disclosure of the present specification and common technical knowledge in the relevant technical field. In the drawings below, members and portions that elicit identical effects will be explained while denoted by identical reference numerals. The dimensional relationships (length, width, thickness and so forth) in the figures do not necessarily reflect actual dimensional relationships. In the present specification a numerical value range notated as “A to B” denotes a value “equal to or larger than A and equal to or smaller than B”.

### First Embodiment

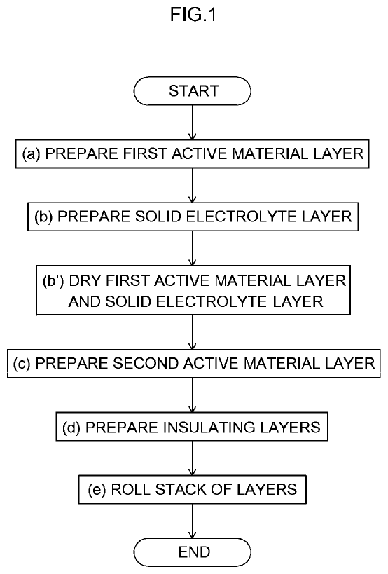

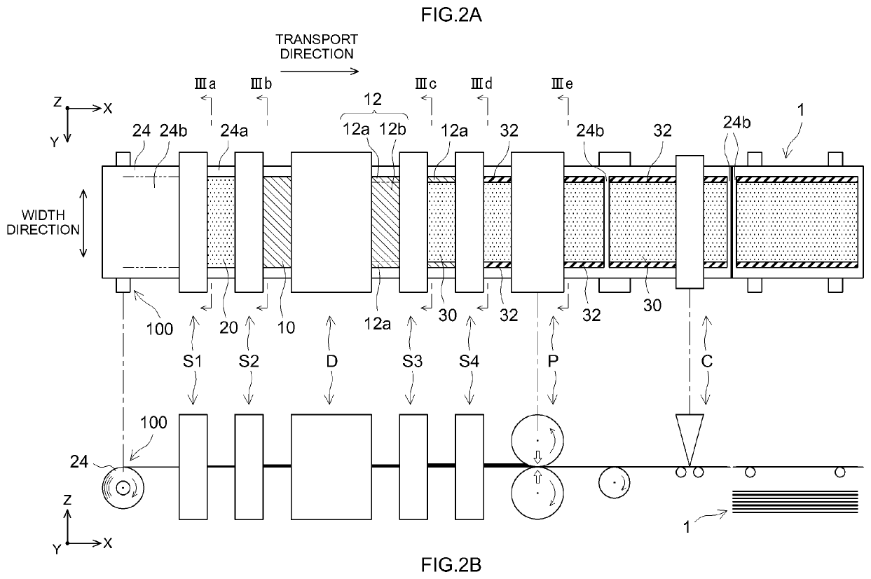

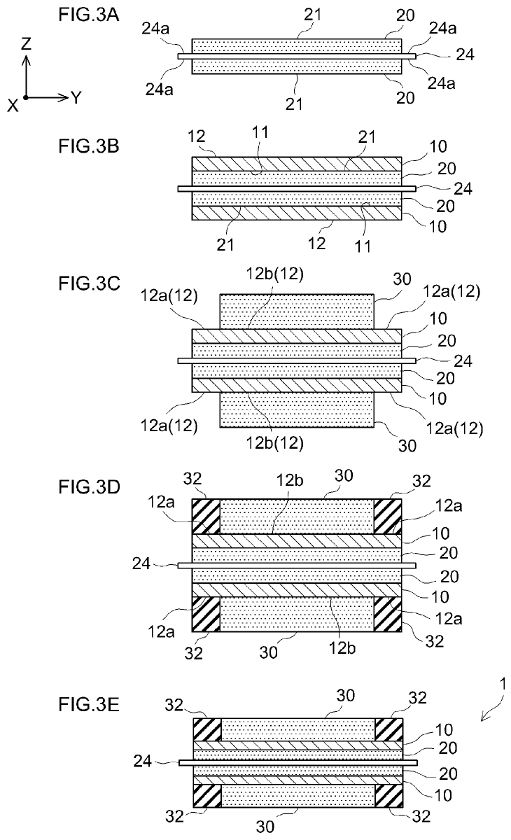

FIG. 1 is a flow diagram illustrating a method for producing an electrode body 1 of an all-solid-state battery according to an embodiment. The method for producing the electrode body 1 includes step (a) to (e) and step (b′). FIG. 2 is a schematic diagram illustrating a production process of the electrode body 1 in the present embodiment. FIG. 2A illustrates a plan-view diagram of the production of the electrode body, viewed from above. FIG. 2B is a side-view diagram of the same, viewed from the side. The arrows X, Y, Z in the figures denote three respective mutually orthogonal directions, where X represents a longitudinal direction (transport direction), Y represents a width direction and Z represents a thickness direction (vertical direction). FIG. 3 is a cross-sectional schematic diagram of the electrode body 1 being prepared in step (a) to (e) during production.

The reference symbols S1, S2, S3, S4 in FIG. 2 all denote slurry coating devices. The slurry coating devices S1, S2, S3, S4 are provided in the order slurry coating device S1, slurry coating device S2, slurry coating device S3 and slurry coating device S4, sequentially from the upstream side in the transport direction X. The configuration of the slurry coating devices is not particularly limited, and may be for instance that of various types of known coating devices, such as gravure coaters, slit coaters, die coaters, comma coaters, dip coaters, blade coaters or the like. The slurry coating devices S1, S2, S3, S4 in the present embodiment are die coaters. The reference symbol D in the figures denotes a dryer. The configuration of the dryer is not particularly limited, and for instance the dryer may be a heat dryer, a blower dryer, an infrared dryer, a freeze dryer or the like. The reference symbol P in the figures denotes a rolling device. The rolling device P in the present embodiment is a hot-roll rolling machine. The reference symbol C in the figures denotes a cutting device such as cutter, a laser cutting machine or the like.

As a typical configuration, the electrode body 1 that is produced in the present embodiment contains a solid electrolyte layer 10, a first active material layer 20 and a second active material layer 30. The first active material layer 20 is provided on a first surface 11 of the solid electrolyte layer 10. The second active material layer 30 is provided on a second surface 12 of the solid electrolyte layer 10 on the opposite side to the first surface 11. The first active material layer 20, solid electrolyte layer 10 and the second active material layer 30 are each provided on both faces of a collector 24. The constituent materials of the various constituent elements will be explained in brief first.

The solid electrolyte layer 10 contains mainly a solid electrolyte material. The solid electrolyte layer 10 contains typically a powdery solid electrolyte material and a binder. The binder binds the particles of powdery solid electrolyte material to each other, and fixes the solid electrolyte material to other layers. Various materials that can be utilized as solid electrolytes in all-solid-state batteries can be used herein as the solid electrolyte material.

“Consisting primarily of” in this Description means that the component is contained in the amount of at least 50 mass %, or preferably at least 60 mass %. More preferably the amount may be at least 70 mass % (such as at least 80 mass %, or at least 90 mass %, or at least 95 mass %).

For instance various compounds having lithium ion conductivity can be suitably used as the solid electrolyte material. Examples of such solid electrolyte materials include specifically, for instance amorphous sulfides such as Li₂S—SiS₂, LiI—Li₂S—SiS₂, LiI—Li₂S—P₂S₅, LiI—Li₂S—B₂S₃, Li₃PO₄—Li₂S—Si₂S, Li₃PO₄—Li₂S—SiS₂, LiPO₄—Li₂S—SiS, LiI—Li₂S—P₂O₅, LiI—Li₃PO₄—P₂S₅, LiI—Li₃PS₄—LiBr, Li₂S—P₂S₅, Li₂S—P₂S₅—LiI—LiBr and Li₂S—P₂S₅—GeS₂; amorphous oxides such as Li₂O—B₂O₃—P₂O₅, Li₂O—SiO₂, Li₂O—B₂O₃ and Li₂O—B₂O₃—ZnO; crystalline sulfides such as Li₁₀GeP₂S₁₂; crystalline oxides such as Li_{1.3}Al_{0.3}Ti_{0.7} (PO₄)₃, Li_{1+x+y}A¹ₓT₁₂₋ₓSi_{y}P_{3-y}O₁₂ (where Al is Al or Ga, 0≤x≤0.4 and 0<y≤0.6), [(A²_{1/2} Li_{1/2})_{1-z}C_{z}]TiO₃ (where A² is La, Pr, Nd or Sm, C is Sr or Ba, and 0≤z≤0.5), Li₅La₃Ta₂O₁₂, Li₇La₃Zr₂O₁₂, Li₆BaLa₂Ta₂O₁₂ and Li_{3.6}Si_{0.6}P_{0.4}O₄; crystalline oxynitrides such as Li₃PO_{(4-3/2w)}N_{w} (w<1); crystalline nitrides such as Li₃N; as well as crystalline iodides such as LiI, LiI-Al₂O₃ and Li₃N—LiI—LiOH. Among the foregoing amorphous sulfides can be used preferably, since these exhibit excellent lithium ion conductivity. The average particle size of the solid electrolyte powder is not particularly limited, and for instance the average particle size (D₅₀) thereof is appropriately about 0.1 μm or greater, preferably 0.4 μm or greater. The volume-average particle size of the solid electrolyte powder is for instance 50 μm or smaller, preferably 5 μm or smaller. A semisolid polymer electrolyte such as polyethylene oxide, polypropylene oxide, polyvinylidene fluoride or polyacrylonitrile containing a lithium salt can also be used as the solid electrolyte.

The term average particle size in the present specification denotes a particle size corresponding to a cumulative 50%, from the small particle size side, in a volume-basis particle size distribution obtained from a particle size distribution measurement based on a laser diffraction-light scattering method. Also, a value resulting from measurement using an electronic microscope (for instance a scanning electronic microscope: SEM) or the like can be taken as the average particle size.

Either one of the first active material layer 20 and the second active material layer 30 can be made up of a positive electrode active material layer, the other being made up of a negative electrode active material layer. The positive electrode active material layer contains mainly a positive electrode active material. The negative electrode active material layer contains mainly a negative electrode active material. The positive and negative active material layers contain typically powdery active material particles. The active material particles in the positive-exhaust gas active material layers are bonded to each other by a binder, and are fixed to the collector 24 and/or other layers by the binder.

Various materials that can be used as electrode active materials in all-solid-state batteries can also be utilized herein as the positive electrode active material and the negative electrode active material. For instance, various compounds capable of storing and releasing lithium ions can be suitably used herein. There are no clear limits between these positive electrode active materials and negative electrode active materials, and from among two active materials, the one exhibiting a relatively nobler charge and discharge potential can be used in the positive electrode, while the material exhibiting a less noble potential can be used in the negative electrode. Examples of such active materials include for instance lithium-transition metal oxides of layered rock-salt type such as lithium cobaltate (for instance LiCoO₂), lithium nickelate (for instance LiNiO₂), and Li₁₊ₓCo_{1/3}Ni_{1/3}Mn_{1/3}O₂ (where x is 0≤x<1); lithium-transition metal oxides of spinel type such as lithium manganate (for instance LiMn₂O₄), and heterogeneous element-substituted Li—Mn spinels represented by Li₁₊ₓMn_{2-x-y}M¹_{y}O₄ (where M¹ denotes one or more metal elements selected from among Al, Mg, Ti, Co, Fe, Ni and Zn, and x and y satisfy each independently 0≤x and y≤1); lithium titanate (for instance LiₓTiO_{y}, where x and y satisfy each independently 0≤x and y≤1); lithium metal phosphates (for instance LiM²PO₄, where M² is Fe, Mn, Co or Ni); oxides such a vanadium oxides (for instance V₂O₅) and molybdenum oxides (for instance MoO₃); titanium sulfides (for instance TiS₂); carbon materials such as graphite and hard carbon; lithium cobalt nitrides (for instance LiCoN); lithium silicon oxides (for instance LiₓSi_{y}O_{z}, where x, y and z satisfy each independently 0≤x, y and z≤1); metallic lithium (Li); silicon (Si) and tin (Sn), and oxides of the foregoing (for instance SiO and SnO₂); lithium alloys (for instance LiM³, where M³ is C, Sn, Si, Al, Ge, Sb or P); intermetallic compounds capable of storing lithium (for instance MgₓM⁴ and M⁵_{y}Sb, where M⁴ is Sn, Ge or Sb, and M⁵ is In, Cu or Mn); as well as derivatives and composites of the foregoing. The average particle size of the active material particles is not particularly limited, and may be for instance 0.1 μm or greater, or 0.5 μm or greater. The volume-average particle size may be for instance 50 or smaller, or 5 μm or smaller. In a case where the active material particles are used by being processed into a granulated power form, the average particle size of the active material particles, as primary particles, lies preferably within the above ranges.

Part of the active materials may be replaced by the above solid electrolyte material, in order to increase lithium ion conductivity within the first active material layer 20 and the second active material layer 30. In this case, the proportion of the solid electrolyte material contained in the active material layers 20, 30 can be set for instance to 60 mass % or lower, preferably to 50 mass % or lower, and more preferably to 40 mass % or lower, with respect to 100 mass % as the total of the active materials plus the solid electrolyte material. The proportion of the solid electrolyte material is suitably 10 mass % or higher, and is preferably 20 mass % or higher, more preferably 30 mass % or higher. The first active material layer 20 and the second active material layer 30 are made up mainly of the active materials and the solid electrolyte material.

If a positive electrode active material layer of higher potential contains a solid electrolyte made up of a sulfide, a high-resistance reaction layer may become formed at the interface of the positive electrode active material and the solid electrolyte, giving rise to higher interface resistance. Therefore, it is preferable to cover the positive electrode active material particles with a crystalline oxide having lithium ion conductivity, with a view to suppressing such an occurrence. Examples of the lithium ion-conductive oxide that covers the positive electrode active material include for instance oxides represented by formula LiₓA³O_{y} (where A³ is B, C, Al, Si, P, S, Ti, Zr, Nb, Mo, Ta or W, and x and y are positive numbers). Specific examples include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄ and Li₂WO₄. The lithium ion-conductive oxide may be a complex oxide made up of an arbitrary combination, for instance Li₄SiO₄—Li₃BO₃, Li₄SiO₄—Li₃PO₄ or the like, of the above lithium ion-conductive oxides.

In a case where the surface of the positive electrode active material particles is covered with an ion-conductive oxide, it suffices that the ion-conductive oxide cover at least part of the positive electrode active material, and may cover the entire surface of the positive electrode active material particles. For instance, the thickness of the ion-conductive oxide that covers the positive electrode active material particles is preferably 0.1 nm or greater, more preferably 1 nm or greater. For instance, the thickness of the ion-conductive oxide is preferably 100 nm or smaller, more preferably 20 nm or smaller. The thickness of the ion-conductive oxide can be measured using for instance an electron microscope such as a transmission electronic microscope (TEM).

The first active material layer 20 and the second active material layer 30 may contain a conductive material for increasing electron conductivity, as needed. The conductive material is not particularly limited, and for instance there can be used a carbon material such as graphite, carbon black such as acetylene black (AB), Ketjen black (KB) or the like, as well as vapor-grown carbon fibers (VGCFs), carbon nanotubes, carbon nanofibers and the like. The conductive material may be for instance 1 mass % or higher, and for instance may lie in the range of 1 mass % to 12 mass %, or in the range from 2 mass % to 10 mass %, with respect to 100 mass % as the total amount of the electrode active material layers.

The binder is not particularly limited, and various organic compounds having binding properties can be used herein. As the binder, there can be used for instance polytetrafluoroethylene, polytrifluoroethylene, polyethylene, cellulose resins, acrylic resins, vinyl resins, nitrile rubbers, polybutadiene rubbers, butyl rubbers, polystyrene, styrene-butadiene rubbers, styrene-butadiene latex, polysulfide rubbers, acrylonitrile-butadiene rubbers, polyvinyl fluoride, polyvinylidene fluoride (PVDF), fluororubbers and the like. These may be used either alone or in combinations of two or more types.

Various materials having excellent electron conductivity, and which are not readily altered at the charge and discharge potential of the active materials that are used, can be utilized herein as the collector 24. Examples of such materials include for instance aluminum, copper, nickel, iron, titanium and alloys of the foregoing (for instance, aluminum alloys and stainless steel), as well as carbon. The shape of the collector 24 can be for instance a foil shape, a plate shape, a mesh shape or the like. The thickness of the collector 24 depends for instance on the dimensions of the electrode body, and accordingly is not particularly limited, but for example lies preferably in the range of 5 μm to 500 μm, more preferably about 10 μm to 100 μm.

The various steps will be explained next.

a. Preparation of the First Active Material Layer

The first active material layer 20 is prepared in step (a). The first active material layer 20 is prepared on one face or both faces of the collector 24. In the present embodiment, the first active material layer 20 is formed on both faces of the collector 24, as illustrated in FIG. 3A. A coating method is preferably resorted to as the method for producing the first active material layer, since coating is comparatively a low-cost method excellent in productivity. In the coating method there is prepared the active material layer, and the slurry is supplied to the collector 24, to thereby form the first active material layer 20. The slurry for the first active material layer can be prepared by dispersing at least powdery active material particles and a binder in a dispersion medium. An aqueous solvent or nonaqueous solvent (organic solvent) capable of suitably dissolving or dispersing the binder that is utilized can be used herein as the dispersion medium. Examples of such an aqueous dispersion medium include for instance water and a mixed solvent of a lower alcohol having water as a main constituent. Preferred examples of the nonaqueous dispersion medium include for instance ester solvents such as methyl acetate, ethyl acetate, butyl acetate, methyl butyrate, ethyl butyrate, butyl butyrate or the like; hydrocarbon solvents such as toluene, xylene, cyclohexane, heptane or the like, ketone solvents such as acetone, methyl ethyl ketone or the like, and also N-methyl-2-pyrrolidone (NMP), terpineol and the like. The dispersion medium may be used for instance in the form of a binder solution having the binder dissolved therein, or a binder dispersion having the binder dispersed therein. The slurry that is used in the coating method may contain, as needed, for instance a viscosity adjusting agent for adjusting the viscosity of the slurry. The viscosity adjusting agent is not particularly limited, and for instance an organic compound such as carboxymethyl cellulose (CMC) can be suitably used herein. The solids concentration of the slurry is not particularly limited, and is appropriately for instance 50 mass % or higher, preferably 60 mass % or higher and more preferably 70 mass % or higher. The solids concentration of the slurry may be for instance 80 mass % or lower, from the viewpoint of slurry suppliability.

The first active material layer 20 of the present embodiment is for instance a negative electrode active material layer. A negative electrode slurry can be prepared by dispersing a silicon (Si) powder having an average particle size of 4 μm, as a negative electrode active material, LiI—Li₃PS₄—LiBr having an average particle size of 1 μm, as a solid electrolyte, and AB as a conductive material, in a binder solution, using a FILMIX disperser. The binder solution was prepared by dissolving PVDF as a binder, in butyl butyrate, to a concentration of 5 mass %. The softening point of the PVDF that is used lies in the range of 134° C. to 169° C. A copper foil having a thickness of about 15 μm and a tensile strength of 500 N/mm² or greater at 25° C. was used as the collector 24.

As illustrated in FIG. 2, the collector 24 is prepared for instance in the form of a collector roll 100 resulting from winding of an elongate foil-shaped collector 24 into a roll shape. The collector 24 is paid out from the collector roll 100 and is continuously transported along the transport direction X by a transport means, not shown. The slurry for the first active material layer is coated onto both faces of the transported collector 24, by the slurry coating device S1 provided on the transport path. Active material layer non-formation sections 24a at which the collector 24 is exposed and onto which the slurry for the first active material layer is not supplied, are provided at both edges of the collector 24, in the width direction Y perpendicular to the longitudinal direction X. The collector 24 is transported continuously using the active material layer non-formation sections 24a. The slurry coating device S1 can apply intermittently the slurry for the first active material layer onto the collector 24, depending on the dimensions of the desired electrode body 1. As a result, active material layer non-formation sections 24b at which the collector 24 is exposed are provided over the width direction Y, between two first active material layers 20 adjacent in the longitudinal direction X (see FIG. 2A). Respective first active material layers 20 having a desired dimension in the longitudinal direction X and the width direction Y can be prepared as a result on the surface of the collector 24. The surface of each first active material layer 20 on the side not in contact with the collector 24 is referred to as a first surface 21.

b. Preparation of Solid Electrolyte Layer

In step (b) there are prepared respective solid electrolyte layers 10 in such a manner that the first surface 21 of each first active material layer 20 and the first surface 11 of a respective solid electrolyte layer 10 are in contact with each other. The surface of the solid electrolyte layer 10 in contact with the first active material layer 20 is referred to as first surface 11, and the surface not in contact with the first active material layer 20 is referred to as second surface 12. In the present embodiment the solid electrolyte layers 10 are formed on respective first surfaces 21 of the two first active material layers 20 that are formed on both faces of the collector 24. Each solid electrolyte layer 10 in the present embodiment is formed in accordance with a coating method, similarly to the first active material layer 20.

The solid electrolyte slurry used in the coating method can be prepared through dispersion of a powdery solid electrolyte in a binder solution. In the present embodiment LiI—Li₃PS₄—LiBr having an average particle size of 1 similar to that utilized in the first active material layer 20, was used as the solid electrolyte. Further, a 5 mass % butyl butyrate solution of PVDF was used as the binder solution, similarly to the case of the binder solution used in the first active material layer 20. The foregoing are dispersed and mixed in a FILMIX disperser, to thereby prepare the solid electrolyte slurry.

The solid electrolyte slurry is accommodated in the slurry coating device S2 provided on the transport path, and is coated onto the first surface 21 of each first active material layer 20 having been formed in step (a). As illustrated in FIG. 3B, the solid electrolyte slurry is supplied over the entire surface of each first surface 21 of the first active material layer 20. Each solid electrolyte layer 10 can be prepared as a result to cover the entirety of the first surface 21 of each first active material layer 20.

b′. Drying of the First Active Material Layer and the Solid Electrolyte Layer

The first active material layer 20 and solid electrolyte layer 10 having been prepared in step (a) and (b) are dried in step (b′). Step (b′) is not essential, but is preferably carried out since doing so allows producing quickly an electrode body 1 of good quality. In step (b′) the first active material layer 20 and the solid electrolyte layer 10 formed on the collector 24 are transported together with the collector 24, as illustrated in FIG. 2, and are introduced into the dryer D. The dispersion medium (herein butyl butyrate) in the slurry is removed as the first active material layer 20 and the solid electrolyte layer 10 pass through the dryer D. The drying conditions in the present embodiment involve 20 minutes at 120° C. As a result, it becomes possible to obtain a stack of the first active material layer 20 and the solid electrolyte layer 10, as the dried product. The thickness of the first active material layer 20 that is formed is about 50 μm, and the packing density (bulk density) is about 50 vol %. The thickness of the solid electrolyte layer 10 is about 55 μm, and the packing density (bulk density) is about 50 vol %. In the present specification the “thickness” of each layer denotes average thickness. The dimensions in the width direction Y of the first active material layer 20 and solid electrolyte body 10 are roughly the same in this embodiment.

c. Preparation of Second Active Material Layer

In step (c) there are prepared second active material layers 30 so as to be in contact with a respective second surface 12 of the solid electrolyte layers 10. As illustrated in FIG. 3C, the second surface 12 of each solid electrolyte layer 10 is divided into peripheral edge sections 12a being at least part of the peripheral edge, and into a stack section 12b excluding the peripheral edge sections 12a. Each second active material layer 30 is prepared so as to be in contact with a respective stack section 12b. In other words, the second active material layer 30 is prepared so as not to be in contact with the peripheral edge sections 12a. The dimension of the second active material layer 30 in the surface direction is smaller, by the peripheral edge sections 12a, than that of the first active material layer 20 and the solid electrolyte layer 10. Each second active material layer 30 in the present embodiment is formed in accordance with a coating method, similarly to the first active material layer 20.

The second active material layers 30 in one preferred embodiment of the present invention are for instance positive electrode active material layers. There was prepared a lithium-transition metal oxide (LiCo_{1/3}Ni_{1/3}Mn_{1/3}O₂) powder having an average particle size of 4 μm, as a positive electrode active material, a Li₂S—P₂S₅ amorphous sulfide containing LiI and having an average particle size of 0.8 μm, as a solid electrolyte, and VGCF as a conductive material. The foregoing were dispersed in a 5 mass % butyl butyrate solution of PVDF, as a binder solution, to thereby prepare a positive electrode slurry.

The positive electrode slurry is applied to the stack section 12b of each solid electrolyte layer 10 having been dried in step (b′), by the slurry coating device S3 provided on the transport path. In the present embodiment, the second surface 12 of the solid electrolyte layer 10 was set so that the peripheral edge sections 12a run along both edges in the width direction Y, as illustrated in FIG. 2A. The stack section 12b is set to the central portion in the width direction Y, excluding the peripheral edge sections 12a, on the second surface 12 of the solid electrolyte layer 10. As a result, the surface area of each second active material layer 30, in a plan view, is smaller than the surface area of the solid electrolyte layer 10 and of the first active material layer 20. Therefore, the second active material layer 30 is formed so that the dimension (thickness) thereof in the vertical direction Z is thicker than the dimension of the first active material layer 20, in order to even out a volume ratio of the first active material layer 20 and of the second active material layer 30 (see FIG. 3C). The second active material layer 30 can be prepared as a result. The thickness of the second active material layer 30 thus formed is for instance about 70 and the packing density is about 50 vol %.

d. Preparation of Insulating Layers

In step (d) there are prepared insulating layers 32 so as to be in contact with the peripheral edge sections 12a of the solid electrolyte layer 10. The insulating layers 32 have an insulating function of preventing contact between the edges of the first active material layer 20 and of the edges of the second active material layer 30, being squashed through rolling in the subsequent step (e). The insulating layers 32 may be composed of an insulating material that lacks electronic conductivity. The insulating layers 32 may be composed for example of an insulating material that lacks both electron conductivity and lithium ion conductivity. The insulating layer 32 may be mainly composed an insulating material. Respective insulating layer members formed to a predetermined shape corresponding to the peripheral edge sections 12a may be prepared beforehand, and be then disposed on the peripheral edge sections 12a of each solid electrolyte layer 10, to yield the insulating layers 32. Alternatively, the insulating layers 32 may be prepared by supplying a precursor material of the insulating material that makes up the insulating layers 32 to the peripheral edge sections 12a of the solid electrolyte layer 10, followed by curing.

The insulating material is not particularly limited, and may be composed of a thermoplastic resin such as polyethylene (PE), polypropylene (PP), polyethylene terephthalate (PET) or polyethylene naphthalate (PEN), a thermosetting resin such as epoxy resin, phenol resin, unsaturated polyester resin, urea resin, melamine resin, urethane resin or imide resin, an engineering plastic such as polyamide, polyimide, polyacetal, polycarbonate or modified polyphenylene oxide, a super engineering plastic such as polyphenylene sulfide (PPS), polyether sulfone (PES), polyether ether ketone (PEEK), polyether imide (PEI) or modified polyamide, a photocurable resin that is polymerized and cured when light energy is supplied, an insulating ceramic such as alumina, silica, titanic, ceria, zirconia, boehmite, aluminum hydroxide or magnesium hydroxide, or a solid electrolyte material or the like. Of these, an inorganic material such as an insulating ceramic or solid electrolyte material is preferred as the insulating material for the purpose of appropriately adjusting the relationship between compression deformation resistances of the insulating layer 32 and positive electrode active material before rolling as discussed below, and alumina or the aforementioned sulfide solid electrolyte or the like is more preferred.

An “engineering plastic” here is a material that has heat resistance (typically, has at least one of a deflection temperature under load and a continuous operating temperature) at a temperature of at least 100° C., and also has a tensile strength of at least 49 MPa and a flexural modulus of at least 2.5 GPa. A “super engineering plastic” is an engineering plastic that has heat resistance at a temperature of at least 150° C.

The deflection temperature under load is the temperature at which the magnitude of deflection is at least a certain value when the temperature is raised while applying a certain load to a resin material in accordance with the methods stimulated by ASTM D648 or JIS K 7191-1:2015. The continuous operating temperature is the temperature at which continuous use is possible in a load-free environment and is defined by the relative thermal index (RTI) in accordance with the methods stipulated by the U.S. UL standard UL746B.

When the insulating material is the aforementioned resin (curable material), the precursor material may be a resin composition containing a monomer, oligomer, prepolymer or the like of the resin for example. When the resin is a photocurable resin, the photocurable resin composition used as the uncured photocurable resin may contain an additive such as a photopolymerization initiator. In a case where the insulating material is the above insulating ceramic, for instance a powder containing a binder and particles made up of the insulating ceramic, or a slurry resulting from dispersing the powder in a dispersion medium, can be used as the precursor material. When the insulating material contains a solid electrolyte material, this solid electrolyte material may be the same as or different from the solid electrolyte material constituting the solid electrolyte layer 10. These materials may be used for instance in combinations of two or more different materials in order to adjust a below-described compressive deformation resistance ratio.

The insulating material in the present embodiment is an alumina powder molded product. The alumina powder molded product can be prepared by coating the peripheral edge sections 12a of the solid electrolyte layer 10 with an alumina slurry, as a precursor material, similarly to the first active material layer 20, and through removal of the dispersion medium. The alumina slurry can be prepared by dispersing alumina powder having an average particle size of 4 μm in a 5 mass % NMP solution of PVDF, as a binder solution, using a FILMIX disperser.

The alumina slurry is coated onto the peripheral edge sections 12a of the solid electrolyte layer 10, by the slurry coating device S4 provided on the transport path. As illustrated in FIG. 3D, the alumina slurry in the present embodiment is supplied so as to be in contact with the edges of each second active material layer 30 in the width direction Y. In other words, the alumina slurry is supplied so as to fill up the step sections formed on the surface of the solid electrolyte layer 10 and of the second active material layer 30. Thereafter, the insulating layers 32 are formed through removal of the dispersion medium in the alumina slurry, by volatilization. As a result, there can be formed a stack in which the first active material layer 20, the solid electrolyte layer 10 formed therein, the second active material layer 30 and the insulating layers 32 are laid up on each other.

As illustrated in FIG. 3D, the insulating layers 32 are provided in this stack on both edges of each second active material layer 30 in the width direction Y. In this stack the first active material layer 20 as a first layer the solid electrolyte layer 10 as a second layer, and the second active material layer 30 and the insulating layers 32 as a third layer, are formed on both faces of the collector 24, such that the edges of the foregoing layers in the width direction Y are substantially even with respect to each other. In the present embodiment, the coating amount of the alumina slurry is adjusted in such a manner that the thickness of the insulating layers 32 is substantially identical to the thickness of the second active material layer 30. The surface of the insulating layers 32 and of the second active material layer 30 in the present embodiment are formed to be substantially flush. The thickness of the insulating layers 32 thus formed is for instance about 70 μm, and the packing density is about 50 vol %. The thickness of the stack is for instance about 400 μm.

e. Rolling of the Stack of Layers

In step (e), the stack prepared in step (d) is pressed in the stacking direction (i.e. in the thickness direction Z). The stack is transported along the transport direction X, as illustrated in FIG. 2, and is fed to the rolling device P. The stack passes through the rolling device P, and is densely rolled as a result. It becomes accordingly possible to obtain an electrode body 1 of high packing density, having a compressed dimension in the thickness direction as illustrated in FIG. 3E.

A hot roll press is used as the rolling device P in the present embodiment. For the pressing apparatus, a roll pressing apparatus is advantageous for obtaining smooth compression of the stack during transport. The rolling condition by the rolling device P involves preferably substantial rolling, with a linear pressure of 10 kN/cm or higher. The linear pressure is more preferably 30 kN/cm or higher, yet more preferably 40 kN/cm or higher, and particularly preferably 50 kN/cm or higher. The upper limit of the linear pressure is not particularly restricted, and can be set as appropriate in accordance with the rolling capacity of the rolling device P and the shape retention characteristic of the stack. It is thus possible to compress the stack more densely with a single pressing. Rolling is preferably carried out under heating, from the viewpoint of achieving a denser electrode body 1. The heating temperature at the time of rolling is not particularly limited, but for instance there is preferably set a temperature (herein 170° C. or higher) equal to or higher than the softening point of the binder contained in the first active material layer 20, the solid electrolyte layer 10, the second active material layer 30 and the insulating layers 32. The thickness of the electrode body 1 thus obtained is for instance about 225 μm (reduction ratio: about 44%). Needless to say, the heating temperature during rolling can be set to a temperature lower than the temperature at which the materials that are used suffer unintended alteration. For instance, the heating temperature can be set to a temperature lower than the temperature at which thermal decomposition of the binder starts.

The electrode body 1 thus obtained is formed, as a plurality of bodies spaced apart from each other by the active material layer non-formation sections 24b, on both faces of the elongate collector 24. Therefore, the collector 24 is for instance cut along the width direction Y, at the active material layer non-formation sections 24b, using the cutting device C, to thereby obtain individually a plurality of electrode bodies 1, as illustrated in FIG. 2.

The production method disclosed herein allows thus producing an electrode body 1 in one single rolling (pressing), by resorting to rolling by pressure higher than in conventional art. Rolling can be performed that so that the compression ratio (reduction ratio) in the thickness direction during rolling is for instance 20% or higher, more preferably 30% or higher, yet more preferably 40% or higher, for instance 45% or higher, particularly preferably 50% or higher. In conventional rolling the packing density of the layers in the electrode body could be increased to just about 70 vol %. In the art disclosed herein, by contrast, the packing density of the layers in the obtained electrode body 1 is for instance about 50 vol % before rolling, but can be increased up to about 80 vol % or higher, more preferably about 85 vol % or higher, yet more preferably about 90 vol % or higher. As a result, it becomes possible to produce, in a simple manner, an electrode body 1 having low internal resistance, and in which interface resistance between layers is kept low.

The linear pressure exerted by this roll pressing acts on the stack in the thickness direction Z, but also has a relatively large effect in the width direction Y. Tensile stress thus acts on the stack in the width direction Y as a result of rolling. The second active material layer 30 is formed to a smaller dimension in the width direction Y, and accordingly the dimension in the thickness direction Z is for instance relatively larger than that of the first active material layer 20. As a result, the extent of deformation in the width direction Y arising from rolling tends to be large. In a case in particular where the second active material layer 30 is a positive electrode active material layer containing a lithium-transition metal oxide widely used as a positive electrode active material, the metal oxide can be harder than the active material (typically a carbon material or a metallic material) frequently used as a solid electrolyte or negative electrode active material. As a result, compressive deformation of the second active material layer 30 through rolling is likelier to occur than densification. In the above configuration, however, the insulating layers 32 are provided on both edges of the second active material layer 30 in the width direction Y. As a result, it becomes possible to prevent short-circuiting of the second active material layer 30 with the first active material layer 20, caused by significant deformation of the second active material layer 30 in the width direction Y.

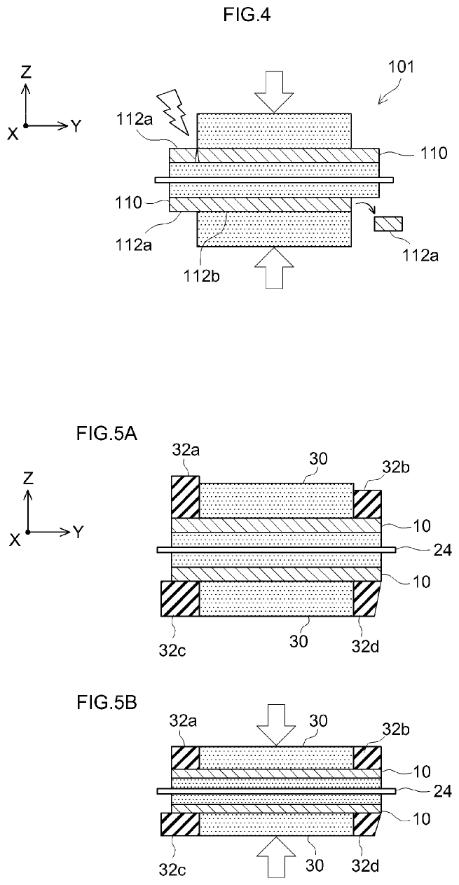

As illustrated in FIG. 3D, the level difference at the surface of the solid electrolyte layer 10 and the second active material layer 30 is filled up by the insulating layers 32. As a result, pressure can be exerted uniformly onto the second surface 12 of the solid electrolyte layer 10, even upon substantial rolling with high pressure. In other words, there is moderated the difference in pressure acting on the stack section 12b and the peripheral edge sections 12a of the solid electrolyte layer 10. In a case in particular where the insulating layers 32 are a ceramic powder molded product, the compressive deformation behavior of the insulating layers 32 and the second active material layer 30 can be approximated, and accordingly pressure can be transmitted uniformly by the solid electrolyte layer 10. As a result, there can be suppressed the observed occurrence of rolling cracks at a boundary between peripheral edge sections 112a and a stack section 112b of a solid electrolyte layer 110 in a conventional electrode body 101, for instance as illustrated in FIG. 4. As a result, it becomes possible to obtain an electrode body 1 in which the first active material layer 20, the solid electrolyte layer 10 and the second active material layer 30 are rolled uniformly to a high packing density.

As illustrated in FIG. 3E, the surface heights of the second active material layer 30 and the insulating layers 32 are identical, and the layers thus flush, in the electrode body 1 obtained after rolling. Physical properties of the second active material layer 30 and of the insulating layers 32, such as deformation behavior with respect to pressure, are likewise similar. As a result, this electrode body 1 allows for instance suppressing concentration of stress at the boundary between the peripheral edge sections 12a and the stack section 12b of the solid electrolyte layer 10, even when for example stress acts on the electrode body 1 due to vibration during the use of the all-solid-state battery. Therefore, it becomes possible to produce an electrode body 1 in which there are suppressed for instance fatigue cracks of the solid electrolyte layer 10, not only during production but also during use. This is preferable since in that case there is achieved a particularly pronounced effect in an electrode body 1 of higher packing density in the layers. Further, the above feature is preferred in terms of bringing out the above effect more effectively, in particular upon repeated charge and discharge in an electrode body 1 configured by containing, as the electrode active material, a material that exhibits significant changes in volume with charge and discharge (for instance a carbon material or a Si-based material, in particular a Si-based material).

In the present embodiment the first active material layer 20, the solid electrolyte layer 10, the second active material layer 30 and the insulating layers 32 were all prepared in accordance with a coating method. The first active material layer 20, the solid electrolyte layer 10, the second active material layer 30 and the insulating layers 32 were formed integrally in that order. However, the art disclosed herein is not limited thereto. For instance, the first active material layer 20, solid electrolyte layer 10, the second active material layer 30 and insulating layers 32 can be prepared independently from each other in accordance with known methods such as powder compression molding, granulated powder compression molding, thin-film forming and the like. The layers may be formed integrally one by one, or may be formed as independent separate layers. In a case where the layers are formed independently, the respective layers may be formed on the collector 24 or on any carrier sheet beforehand, and the formed layers are superimposed on each other in steps (a) to (d), to be then integrally joined to each other in the rolling step (e).

In the above embodiment, step (c) and step (d) were carried out independently in that order. However, the art disclosed herein is not limited thereto. Among step (c) and step (d), for instance, step (d) may be carried out prior to step (c); alternatively, step (c) and step (d) may be carried out simultaneously. In a case where step (c) and step (d) are carried out simultaneously, although not limited thereto, there can be used for instance a multi-stripe coating device capable of simultaneously applying a slurry for a second active material and an alumina slurry in the form of stripes.

In the above embodiment the drying step (b′) was carried out after step (a) and (b) by slurry coating. However, the art disclosed herein is not limited thereto. For instance, step (b′) can be omitted in a case where the layers are prepared in accordance with a method such as powder compression molding, granulated powder compression molding, thin-film forming or the like.

In the above embodiment, the dispersion medium was removed by volatilization in step (d) by slurry coating. However, the art disclosed herein is not limited thereto, and for instance a drying step (d′) may be carried out after step (d).

In the above embodiment, the rolling step (e) was carried out after step (d) by slurry coating. However, the art disclosed herein is not limited thereto, and for instance the step of preparing a second collector on the second active material layer 30 and the insulating layers 32 can be carried out prior to step (e). A step of preparing a stack by superimposing a plurality of the stacks shown in FIG. 3D with second collectors in between may also be performed. Similarly to the collector 24, various materials having excellent electron conductivity, and which are not readily altered at the charge and discharge potential of the electrode active material contained in the second active material layer 30, can be utilized herein as the second collector. For instance, an aluminum foil can be used preferably. It is thus possible to obtain an electrode body 1 with a configuration containing one or two or more storage units each comprising a first active material layer 20, a solid electrolyte layer 10, and second active material layer 30 and an insulating layer 32 integrated between two collectors.

In the above embodiment electrode bodies 1 were cut from each other through cutting of the collector 24 after the rolling step (e). However, the timing of cutting of the collector 24 is not limited to after the rolling step (e). For instance, the collector 24 may be cut prior to the rolling step (e).

In the above embodiment, the rolling step (e) was carried out through roll rolling using a hot-roll rolling machine. However, the art disclosed herein is not limited thereto, and for instance the rolling step (e) may be carried out by means by flat pressing using a flat-plate rolling machine. Although not limited thereto, the rolling step (e) can be preferably carried out using a flat press, in a case where the collector 24 is cut prior to the rolling step (e), as described above. The surface pressure in the case of flat pressing can be for instance set preferably to 200 MPa or higher, more preferably to 400 MPa or higher, yet more preferably 600 MPa or higher, particularly preferably 800 MPa or higher, and for instance about 1000 MPa. The upper limit of the surface pressure can be set as appropriate for instance depending on the performance of the flat-plate rolling machine that is used.

In the case of flat pressing, tensile stress in the longitudinal direction X occurs more readily in the layers, in addition to tensile stress in the width direction Y, than in the case of roll rolling. Therefore, the peripheral edge sections 12a may be provided along both edges in the longitudinal direction X, in addition to along both edges in the width direction Y, at the second surface 12 of the solid electrolyte layer 10. In other words, the peripheral edge sections 12a may be provided over the entirety of the peripheral edge of the second surface 12 of the solid electrolyte layer 10. In conjunction therewith, the insulating layers 32 may be provided over the entirety of the peripheral edge of the second surface 12 of the solid electrolyte layer 10. As a result, it becomes possible to suitably prevent short-circuiting between the first active material layer 20 and the second active material layer 30, even upon significant deformation of the second active material layer 30 caused by rolling, not only in the width direction Y but also in the longitudinal direction X.

In the present embodiment the dimensions of the second active material layer 30 and of the insulating layers 32 in the thickness direction Z were formed in such a manner that the surfaces of the second active material layer 30 and of the insulating layers 32 are substantially flush, as illustrated in FIG. 3D, prior to the rolling step (e). The positions of the edges of the insulating layers 32 on the opposite side to the second active material layer 30 in the width direction Y were substantially aligned with the positions of the edges of the solid electrolyte layer 10 in the width direction Y. However, the art disclosed herein is not limited thereto, and the form of the insulating layers 32 may adopt several variations. In the example illustrated in FIG. 5A, for instance, insulating layers 32a, 32b, 32c, 32d having four different cross-sectional shapes are formed prior to the rolling step (e) at both edges of the solid electrolyte layer 10 in the width direction Y, on both faces of the collector 24. For instance, the insulating layer 32a may be thicker than the second active material layer 30. The insulating layer 32b may be thinner than the second active material layer 30. The edge of the insulating layer 32c may protrude beyond the solid electrolyte layer 10, in the width direction Y. The dimensions of the insulating layer 32d in the width direction Y may vary along the thickness direction Z. These insulating layers 32a, 32b, 32c, 32d are rolled, in the rolling step (e), until the surfaces of at least the second active material layer 30 and of the insulating layers 32 are flush with the insulating layers 32a, 32b, 32c, 32d, as illustrated in FIG. 5B. Therefore, the effect of the present art can be elicited in the same way as in the above embodiment, so long as such rolling is enabled.

However an excessive discrepancy in relative thickness between the insulating layers 32a, 32b and the second active material layer 30 is undesirable, since in that case the pressure exerted on the solid electrolyte layer 10 in the rolling step (e) may be uneven. It is therefore preferable for instance that the thickness T1 of the insulating layer 32b before rolling satisfies the relationship 0.6×T2≤T1 and more preferably satisfies the relationship 0.75×T2≤T1, or for example 0.80×T2≤T1 relative to the thickness T2 of the second active material layer 30 before rolling, although these relationships depend on the constituent materials of the second active material layer 30 and insulating 32, and hence are not categorical. The thicknesses T1 and T2 also preferably satisfy the relationship T1≤1.8×T2, or for example T1≤1.6×T2, or T1≤1.4×T2, or T1≤1.25×T2, or T1≤1.2×T2. It is thus possible to roll the solid electrolyte layer 10 more uniformly even when the thicknesses of the second active material layer 30 and the insulating layer 32 are different.

From the standpoint of uniform transmission of pressure by the solid electrolyte layer 10, the second active material layer 30 and insulating layer 32 preferably have similar deformation resistance during compression. The inventors' researches have revealed that for example the compressive deformation resistance ratio (also called the compression modulus of elasticity) E1 of the insulating layer 32b that is prepared in step (d) (that is, before rolling) is preferably in the relationship E1≥0.1× E2 or more preferably E1≥0.2×E2 with respect to the compressive deformation resistance ratio E2 of the second active material layer 30 before rolling. This allows for better transmission of pressure by the solid electrolyte layer 10. Preferably, the compressive deformation resistance ratio E1 is 0.5×E2 or higher, more preferably 0.8×E2 or higher, yet more preferably 0.9×E2 or higher, and particularly preferably E2 or higher. Studies by the inventors have also revealed that the insulating layers 32 may permissibly undergo elongation deformation less readily than the second active material layer 30, so long as that discrepancy is not excessive. Therefore, the compressive deformation resistance ratio E1 is preferably about 2×E2 or lower, more preferably 1.5×E2 or lower, yet more preferably 1.3×E2 or lower, and particularly preferably 1.2×E2 or lower. As a result, it becomes possible to achieve the effect of the present art similarly to the above embodiment, even when the materials of the second active material layer 30 and of the insulating layers 32 are different. This provides guidance for the design of the insulating layers 32.

To balance thorough densification of the second active material layer 30 with suppression of cracks and the like in the solid electrolyte layer 10 at a high level, the thicknesses and compressive deformation resistance ratios of the second active material layer 30 and insulating layer 32 supplied to rolling are preferably in the following relationship. First, preferably E1≥0.2×E2. Furthermore, if (1) 0.2×E2≤E1≤0.5×E2, preferably 0.75×T2≤T1≤1.6×T2. Furthermore, if (2) 0.5×E2<E1, preferably 0.75×T2≤T1≤1.25×T2.

In the present specification, the term compressive deformation resistance ratio denotes the efficiency with which there is transmitted compressive stress that is exerted. For instance, in samples corresponding to the insulating layer 32b before rolling and the second active material layer 30 before rolling, the compressive deformation resistance ratio can be grasped as the slope of a respective stress-strain curve obtained by performing a compression test at a temperature and at a compressive load similar to those in the rolling step (e). When calculating the slope of the stress-strain curve, the slope may be worked out through linear interpolation of the stress-strain curve, given that the thickness of the samples is very small. A yield point and a breaking point may appear in the stress-strain curve if the insulating layer is made up of a composite material similar to that of the second active material layer. In that case the slope may be calculated on the basis of the rule of mixtures, or may be worked out through linear interpolation of the curve at an initial strain region up to the yield point (or breaking point). The compression test can be carried out for instance in accordance with JIS K 7181, K 7056, R 1608 or the like. In practice it is difficult to measure the stress strain characteristic upon application of a compressive load that exceeds 500 MPa, for thin-film samples with an insulating layer and a second active material layer before rolling (typically with a thickness in the range of 100 to 200 μm). To work out the compressive deformation resistance ratio in that case, a value of for instance 500 MPa (representative value) may be adopted as the compressive load in the rolling step (e). The relationship between the compressive deformation resistance ratio E1 of the insulating layer and the compressive deformation resistance ratio E2 of the second active material layer can be derived on the basis of compressive deformation resistance ratios E1 and E2 at the time of application of a compressive force of 500 MPa under temperature conditions from room temperature (25° C.) up to 200° C. (typically 170° C.), for various types of insulating layer sample and second active material layer sample, using for instance a precision universal tester with a specially produced jig.

### Second Embodiment

### (CAE Analysis)

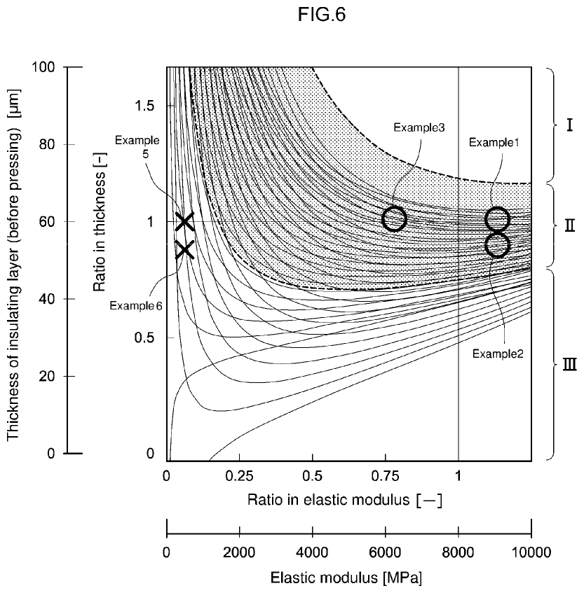

When manufacturing an electrode body for an all-solid-state battery, the rolled state of the solid electrolyte layer that has been subjected to specific rolling in a stack comprising a laminated solid electrolyte layer, positive electrode active material layer and insulating layer was predicted by CAE (computer aided engineering) analysis based on response surface methodology, with the results shown in FIG. 6. In FIG. 6, the ratio of the pre-rolled thickness of the insulating layer relative to the positive electrode active material layer is shown on the vertical axis, and the ratio of the elastic modulus (compression deformation resistance) of the insulating layer relative to the positive active material layer on the horizontal axis. FIG. 6 shows that the region combining regions II and region III is a region in which the relationship between the positive active material layer and the insulating layer is such that compressive stress at or above a specific value is applied to the positive electrode active material layer by pressing. By contrast, when the relationship between the positive active material layer and the insulating layer is in region I, because the insulating layer is too hard and too thick, pressing pressure is exerted only on the insulating layer and the adjacent solid electrolyte layer part, and the positive active material layer does not receive the necessary compressive load. When the relationship between the positive active material layer and the insulating layer is in the region combining region I and region II, on the other hand, although compressive stress is applied to the solid electrolyte layer via the adjacent insulating layer, no tensile stress is exerted in the transport direction during roll pressing. By contrast, if the relationship between the positive active material layer and the insulating layer is in the region III instead (region from left side to lower half), because the insulating layer is too soft and too thin, the solid electrolyte layer adjacent to the insulating layer cannot be compressed, and tensile stress is exerted on the solid electrolyte layer adjacent to the insulating layer, causing cracks and the like in the insulating layer and solid electrolyte layer. Thus, if the relationship between the positive active material layer and the insulating layer is in the region II, the positive active material layer can be properly densified without causing cracks and the like in the solid electrolyte layer.

[Electrode Body Preparation Test]

The following electrode body preparation test was performed to confirm the accuracy of the predictions from CAE analysis in FIG. 6. FIG. 6 also shows the results of this electrode body preparation test.

### Examples 1 and 2

A lithium transition metal oxide (LiCo_{1/3}Ni_{1/3}Mn_{1/3}O₂) powder with an average particle diameter of 4 μm as a positive electrode active material, An LiI-containing Li₂S—P₂S₅ glass ceramic with an average particle diameter of 0.8 μm as a sulfide solid electrolyte, VGCF as a conductive material, a 5 mass % butyl butyrate solution of PVdF as a binder solution and a butyl butyrate solution as a dispersion medium were stirred with a Filmix disperser to obtain a positive electrode paste.

Silicon powder with an average particle diameter of 5 μm as a negative electrode active material, an LiI-containing Li₂S—P₂S₅ glass ceramic with an average particle diameter of 2.5 μm as a sulfide solid electrolyte, a 5 mass % butyl butyrate solution of PVdF as a binder solution and a butyl butyrate solution as a dispersion medium were stirred for 30 seconds in an ultrasound disperser to obtain a negative electrode paste.

An LiI-containing Li₂S—P₂S₅ glass ceramic with an average particle diameter of 2.5 μm as a sulfide solid electrolyte, a 5 mass % heptane solution of a butadiene rubber (BR) binder, and heptane as a dispersion medium were stirred for 30 seconds in an ultrasound disperser to obtain an SE layer paste.

Alumina powder with an average particle diameter of 5 μm as an insulating layer material, a 10 mass % mesitylene solution of a butadiene (BR) binder, and mesitylene as a dispersion medium were stirred for 30 seconds in an ultrasound disperser to obtain an insulating layer paste.

The positive electrode paste and the SE layer paste were each coated by the blade method onto aluminum foil, and dried for 30 minutes on a 100° C. hot plate to prepare a positive electrode active material layer and SE layer. The thickness of the positive electrode active material layer was 60 μm. Next, the negative electrode paste was coated by the blade method onto one side of a copper foil and dried for 30 minutes on a 100° C. hot plate, and the negative electrode paste was then coated by the blade method on the other side of the copper foil and dried for 30 minutes on a 100° C. hot plate to obtain a negative electrode comprising negative electrode active material layers on both sides of a copper foil. The negative electrode active material layers and SE layer had the same dimensions in planar view, while the positive electrode active material layer was formed with a narrower dimension than the SE layer in the width direction.

The prepared SE layer was superimposed over the negative electrode active material layers on both sides of the prepared negative electrode and roll pressed at room temperature (25° C.), after which the aluminum foil was peeled off to form an SE layer by the transfer method on the negative electrode. The positive electrode active material layer was transferred to the SE layer in the same way. The SE layer and negative electrode active material layer were thus formed with both ends protruding beyond the positive electrode active material layer in the width direction, with steps formed in four locations on both sides between the SE layer and the positive electrode active material layer in the width direction. These steps were about 2 mm in width, and the step height was 60 μm, matching the thickness of the positive electrode active material layer.

An insulating layer paste was then supplied from a dispenser to the steps and dried for 30 minutes on a 100° C. hot plate to form an insulating layer. However, the insulating layer was formed to a thickness of 60 μm in Example 1 and to a thickness of 55 μm in Example 2. The insulating layer was provided at two locations on each side for a total of four locations on both sides, to prepare a stack. This stack was then sandwiched between two 0.1 mm SUS plates and rolled at a linear pressure of 50 kN/cm with a 170° C. roll press to densify each layer and obtain the electrodes for all-solid-state batteries of Example 1 and Example 2.

### Example 3

The electrode body of Example 3 was obtained as in Example 1 except that an LiI-containing Li₂S—P₂S₅ ceramic with an average particle diameter of 2.5 μm was used as the insulating layer material.

### Example 4

The electrode body of Example 4 was obtained as in Example 1 except that no insulating layer was formed.

### Examples 5 and 6

An acrylic UV curing resin was supplied by the screen-printing method to the steps, and irradiated with UV to form an insulating layer. The insulating layer was formed to a thickness of 60 μm in Example 5 and a thickness of 52 μm in Example 6. Apart from this, the electrodes of Examples 5 and 6 were obtained as in Example 1.

[Elastic Modulus of Insulating Layer]

The insulating layer parts of the electrode bodies of the examples were prepared under the same conditions, and compression tested in a 170° C. environment to measure the compression deformation resistance rates (hereunder simply called “elastic moduli”) of the insulating layers of each example. The results are shown in Table 1 below. For reference, the elastic modulus of the positive electrode active material layer before roll pressing was about 8,000 MPa.

### [Evaluating Solid Electrolyte Layer]

The insulating layers and the solid electrolyte layers in contact with the insulating layers were observed in the electrode bodies of each example, and the presence or absence of cracks and other defects are shown in Table 1 below.

TABLE 1

| | Insulating layer | | | Cracks |
|---|---|---|---|---|
| | Insulating layer | Elastic modulus | Thickness | in SE |
| Example | material | at 170° C. (MPa) | (μm) | layer |
| 1 | Alumina | 9200 | 60 | No |
| 2 | Alumina | 9200 | 55 | No |
| 3 | Solid electrolyte | 6100 | 60 | No |
| 4 | None | — | — | Yes |
| 5 | Acrylic resin | 52 | 60 | Yes |
| 6 | Acrylic resin | 52 | 52 | Yes |

In the electrode bodies of Examples 1 and 2 using alumina as the insulating layer material, it was confirmed that the solid electrolyte layer could be rolled uniformly without irregularities in one roll pressing without causing cracks and the like in the solid electrolyte layer. It was found that using a material such as alumina having an elastic modulus close (about +15%) to that of the positive electrode active material as an insulating layer material, good rolling could be achieved even if there was a difference of about 5 μm (about −8%) between the thicknesses of the positive active material layer and the insulating layer. Even in the electrode body of Example 3, it was confirmed that uniform rolling without irregularities could be achieved by using a solid electrolyte material with an elastic modulus close (about −24%) to that of the positive electrode active material as the insulating layer material.

On the other hand, damage to the solid electrolyte layer during roll pressing (at a linear pressure of at least 20 kN/cm) was confirmed in the electrode body of Example 4 having no insulating layer. In the electrode bodies of Examples 5 and 6 using acrylic resin with an elastic modulus much greater (about −99%) than that of the positive electrode active material as the insulating material, damage to the insulating layer and solid electrolyte layer was confirmed during roll pressing whether the positive electrode active material layer and insulating layer were the same thickness (Example 5) or about 8 μm different (about −13%) (Example 6). In Example 5, it is thought that the insulating layer was damaged because it had too little elasticity to withstand compressive stress. In Example 6, it is thought that because the insulating layer was thin and the rolling stress was exerted on the positive electrode active material layer and the solid electrolyte layer adjacent thereto, the insulating layer and the solid electrolyte layer adjacent thereto were damaged by the tensile stress of the solid electrolyte layer adjacent to the insulating layer and by the difference in tensile strength between the two before the rolling stress could be transmitted to the insulating layer and the solid electrolyte layer adjacent thereto.

As shown in FIG. 6, the relationship between the thicknesses and elastic moduli of the insulating layer and positive electrode active material layer in Examples 1 to 3, 5 and 6 above was confirmed to match the results of CAE analysis. This confirms that an insulating layer and insulating layer material suited to the positive electrode active material layer can be selected in consideration of the rolling conditions. The region II where the solid electrode active material layer can be rolled without irregularities can be roughly represented by (1) or (2) below using the thickness T1 and elastic modulus E1 of the insulating layer before rolling and the thickness T2 and elastic modulus E2 of the positive electrode active material layer. This shows that it is sufficient to design the insulating layer and positive electrode active material layer before rolling so that they satisfy (1) and (2) below.

0.2×E2≤E1≤0.5×E2 and 0.75×T2≤T1≤1.6×T2. (1)

0.5×E2<E1 and 0.75×T2≤T1≤1.25×T2. (2)

### Third Embodiment

In the first embodiment the insulating layers 32 made up of an alumina powder molded product were prepared in step (d) using an alumina slurry. In the present second embodiment an instance will be explained where the insulating layers 32 are prepared in step (d) using an ultraviolet curable resin. Such being the case, step (d) of preparing the insulating layers 32 is carried out before step (c) of preparing the second active material layer. Otherwise, the second embodiment is similar to the first embodiment described above, and an explanation of overlapping features will be omitted.

In the present embodiment, an ultraviolet curable acrylic resin composition was prepared that contained a base polymer of an acrylic monomer, as the material that makes up the insulating layers 32, and a photopolymerization initiator. Further, Shirasu balloons were prepared as an adjusting material for adjusting the compressive characteristics of the insulating layers 32. Shirasu balloons are fine hollow spheres produced using Shirasu, a kind of volcanic ejecta, as a starting material. Shirasu balloons are an inorganic powder that is lightweight, has low bulk density, and comparatively low uniaxial compressive strength. Such Shirasu balloons were blended into the ultraviolet curable acrylic resin composition at a proportion of 50:50, in volume ratio, to prepare an insulating layer material (precursor material).

To produce the electrode body 1 of one preferred embodiment of the present invention there was carried out the drying step (b′), followed by step (d) of preparing the insulating layers 32. Therefore, a resin applicator and an ultraviolet lamp were furnished instead of the slurry coating device S3 illustrated in FIG. 2. The insulating layer material was supplied onto the peripheral edge sections 12a of the solid electrolyte layer 10, using an applicator provided on the transport path, and irradiation from the ultraviolet lamp was elicited, to thereby cure the insulating layer material. As a result, there were formed two rows of insulating layers 32 upright on the peripheral edge sections 12a set on both edges of the solid electrolyte layer 10 in the width direction Y.

Next there was carried out step (c) of preparing the second active material layer 30. Specifically, a positive electrode slurry is supplied between the insulating layers 32 formed along both edges of the solid electrolyte layer 10, similarly to the first embodiment, using the slurry coating device S4. Thereafter, the second active material layer 30 was formed through volatilization of the dispersion medium in the positive electrode slurry. Next, rolling step (e) and cutting of the collector 24 were carried out in the same way as in the first embodiment, to thereby obtain an electrode body 1 of predetermined dimensions. In the obtained electrode body 1, the insulating layers 32 are filled in between the second active material layer 30 and the peripheral edge sections 12a of the solid electrolyte layer 10. The insulating layers 32 are pseudopolymers in which Shirasu balloons are present in a cured product of an acrylic resin.

The above configuration allows shortening significantly the time for preparation of the insulating layers 32, and by extension allows shortening the time required for producing the electrode body 1. It is preferable to carry out step (c) after step (d), since in that case a thick second active material layers 30 can be formed while suppressing sagging on both edges. The compressive strength of the acrylic resin after curing is comparatively high, and thus a problem may occur in that rolling in the subsequent step (e) may be difficult if the insulating layers 32 are formed using an ultraviolet-curable acrylic resin alone. Alternatively, unevenness in the pressure transmitted to the second surface 12 of the solid electrolyte layer 10 may arise on account of rolling, thereby giving rise to cracks in the solid electrolyte layer 10, given that the compression behaviors of the insulating layers 32 and of the second active material layer 30 are significantly dissimilar. In the present embodiment, therefore, an adjusting material is blended into the ultraviolet-curable acrylic resin that makes up the insulating layers 32, to thereby fit the compressive characteristics of the insulating layers 32 to the compressive characteristics of the second active material layer 30. As a result, it becomes possible to suppress the pressure unevenness acting on the solid electrolyte layer 10, obviously during the rolling step (e), but also during use of the all-solid-state battery. Therefore, a high-quality electrode body 1 can be formed where cracks in the solid electrolyte layer 10 are suppressed.

In the present embodiment Shirasu balloons were used as an adjusting material. However, the adjusting material is not limited thereto. For instance, one or more types from among porous ceramic powders, ceramic hollow particles, hollow aggregates of ceramic particles, porous resin particles, hollow resin particles, insulating fibrous fillers and the like can be used alone, or in combinations of two or more types the foregoing, as the adjusting material. The presence of these adjusting materials in the insulating layers 32 of the electrode body 1 can be checked since the insulating layers 32 contain the adjusting material at a high packing density, for instance in the form of a crushed product, squashed product, compressed product or aggregate.

Patent Literature 4 discloses the feature of obtaining a structure for battery construction, followed by sealing of an unsealed portion of the structure for battery construction, as needed, using an insulating resin such as a polyolefin resin or epoxy resin. However, this production method differs from the one provided in the present art as regards the feature wherein the sealing material is filled in after the structure for battery construction is obtained. The structure for battery construction in Patent Literature 4 differs from the electrode body provided in the present art for instance in that the structure is not provided with an electrode active material having a smaller dimension, in the surface direction, than that of the solid electrolyte layer, and in that the above level difference arising from discrepancies in the dimensions of the solid electrolyte layer and of the electrode active material layer are not filled up by the sealing material.

### Applications

In the electrode body 1 disclosed herein the collector 24 can be connected to the first active material layer 20, and a second collector, not shown, can be electrically connected to the second active material layer 30. An all-solid-state battery can then be constructed by accommodating these collectors, or lead-out electrodes electrically connected to the collectors, in a battery case, while drawing the collectors or lead-out electrodes out of the battery case. The form of the battery case is not particularly limited, and can be any one of a box type (rectangular parallelepiped type) form, a cylindrical type form, a cylindrical type form or a laminate pack form. The electrode body 1 may be accommodated in one battery case in a state where multiple electrode bodies (for instance 2 to 10, preferably 2 to 5 bodies) are stacked on each other. The all-solid-state battery may be used by uniformly pressing the central portion of the electrode body 1 for instance in the surface direction, and preferably by uniformly pressing the entirety of the electrode body 1 in the surface direction. The all-solid-state battery can be used in the form of an assembled battery resulting from electrical connection of a plurality of all-solid-state batteries. Such an all-solid-state battery can be used in various applications. Examples of such applications include drive power sources installed in vehicles such as plug-in hybrid vehicles (PHV), hybrid vehicles (HV) and electric vehicles (EV).

Specific examples of the present invention have been explained in detail above, but these are only examples, and do not limit the scope of the claims. The technology described in the claims encompasses various modifications and changes to the specific examples given above.

### REFERENCE SIGNS LIST

1 Electrode body
10 Solid electrolyte layer
20 First active material layer
24 Collector
30 Second active material layer
32 Insulating layer

1. A method for producing an electrode body of an all-solid-state battery, the electrode body including a solid electrolyte layer including a first surface and a second surface opposite side to the first surface, a first active material layer provided on the first surface of the solid electrolyte layer, and a second active material layer provided on the second surface of the solid electrolyte layer, the method comprising:
(a) preparing the first active material layer;
(b) preparing the solid electrolyte layer in such a manner that a first surface of the first active material layer and the first surface of the solid electrolyte layer are in contact with each other;
the second surface of the solid electrolyte layer including a peripheral edge section that is at least part of a peripheral edge, and a stack section excluding the peripheral edge section,
(c) preparing the second active material layer so as to be in contact with the stack section of the solid electrolyte layer;
(d) preparing an insulating layer so as to be in contact with the peripheral edge section of the solid electrolyte layer; and
(e) obtaining the electrode body by pressing a stack including the first active material layer, the solid electrolyte layer, the second active material layer and the insulating layer, in a stacking direction, until surfaces of at least the second active material layer and of the insulating layer are flush with each other
wherein the insulating layer contains at least one of alumina and a solid electrolyte material.

2. The production method according to claim 1, wherein the first active material layer, the solid electrolyte layer and the second active material layer each contain a powder material and a binder.

3. The production method according to claim 1, wherein the first active material layer, the solid electrolyte layer and the second active material layer is each prepared through supply of a slurry containing a powder material, a binder and a dispersion medium, followed by removal of the dispersion medium.

4. The production method according to claim 3, comprising: (b′) a drying step of, subsequently to the step (b), drying the first active material layer and the solid electrolyte layer.

5. The production method according to claim 1, wherein the pressing is carried out under heating at a temperature equal to or higher than the softening point of the binder.

6. The production method according to claim 1, wherein the pressing is carried out by flat pressing at a surface pressure of 200 MPa or higher.

7. The production method according to claim 1, wherein the pressing is carried out by roll rolling at a linear pressure of 10 kN/cm or higher.

8. The production method according to claim 1, wherein in the step (d), a compressive deformation resistance ratio of the insulating layer that is prepared is 1/10 or more a compressive deformation resistance ratio of the second active material layer.

9. The production method according to claim 1, wherein in the step (d), an insulating composition containing at least a photocurable resin composition is supplied to the peripheral edge section, and curing light is irradiated, to thereby prepare the insulating layer containing a photocurable resin.

10. The production method according to claim 9, wherein the insulating composition contains at least one type selected from the group consisting of porous ceramic powders, ceramic hollow particles, hollow aggregates of ceramic particles, porous resin particles, hollow resin particles and insulating fibrous fillers.

11. The production method according to claim 1, wherein the insulating layer is prepared through supply of a slurry containing insulating ceramic particles, a binder and a dispersion medium, followed by removal of the dispersion medium.

12. The production method according to claim 1,
wherein in the step (a), the first active material layer is prepared on both faces of a collector.

13. A method for manufacturing an electrode body for an all-solid-state battery comprising a solid electrolyte layer and a first active material layer bonded to a first surface of the solid electrolyte layer, the method comprising:
a step of superimposing the solid electrolyte layer and the first active material layer when there is a difference between the area of the solid electrolyte layer and the area of the first active material layer at the bonding surface between the solid electrolyte layer and the first active material layer;
a step of providing an insulating layer in a region where it contacts the edges of the smaller of the solid electrolyte layer and the first active material layer and fills in the difference between the layers; and
a step of pressing the solid electrolyte layer, the first active material layer and the insulating layer in the lamination direction of the solid electrolyte layer and the first active material layer
wherein the insulating layer contains at least one of alumina and a solid electrolyte material.

14. (canceled)

15. An electrode body of an all-solid-state battery, comprising:
a solid electrolyte layer;
a first active material layer;
a second active material layer; and
an insulating layer,
wherein the solid electrolyte layer has a first surface and a second surface on the opposite side to the first surface,
the second surface includes a peripheral edge section that is at least part of a peripheral edge of the solid electrolyte layer, and a stack section excluding the peripheral edge section,
the first active material layer is provided on the first surface,
the second active material layer is provided on the stack section,
the insulating layer is provided on the peripheral edge section and contains at least one of alumina and a solid electrolyte material, and
surfaces of the second active material layer and of the insulating layer, on the opposite side to the second surface, are flush with each other.
